(19) United States
(12) Patent Application Publication
(10) Pub. No.: US 2015/0140940 A1
(43) Pub. Date: May 21, 2015

(54) APPARATUS FOR TRANSMITTING MULTIPLE STREAMS AND METHOD FOR TRANSMITTING MULTIPLE STREAMS

(71) Applicant: Electronics and Telecommunications Research Institute, Daejeon (KR)

(72) Inventors: Seung Jae BAHNG, Daejeon (KR); Go San NOH, Hwaseong-si (KR); Jun Woo KIM, Daejeon (KR); Young Jo BANG, Daejeon (KR); Kyung Yeol SOHN, Daejeon (KR); Youn Ok PARK, Daejeon (KR)

(73) Assignee: Electronics and Telecommunications Research Institute, Daejeon (KR)

(21) Appl. No.: 14/537,323

(22) Filed: Nov. 10, 2014

(30) Foreign Application Priority Data
Nov. 19, 2013 (KR) 10-2013-0140349
Mar. 20, 2014 (KR) 10-2014-0032467

(51) Int. Cl. H04B 7/10; H04B 1/04

(52) U.S. Cl. CPC H04B 7/10; H04B 1/04
USPC 455/101

(57) ABSTRACT

Disclosed is an apparatus for transmitting multiple streams, including: a polarized wave control unit generating non-orthogonal polarization information for three or more input streams; a polarized wave generating unit polarizing three or more input streams in a baseband based on the non-orthogonal polarization information to generate vertical and horizontal polarization components; and a polarized wave transmitting unit transmitting the plurality of vertical and horizontal polarization components through dual polarization antennas.

### CROSS-REFERENCE TO RELATED APPLICATIONS

This application claims priority to and the benefit of Korean Patent Application No. 10-2013-0140349 filed in the Korean Intellectual Property Office on Nov. 19, 2013, and Korean Patent Application No. 10-2014-0032467 filed in the Korean Intellectual Property Office on Mar. 20, 2014, the entire contents of which are incorporated herein by reference.

### TECHNICAL FIELD

The present invention relates to an apparatus for transmitting multiple streams and a method for transmitting multiple streams, and more particularly, to an apparatus for transmitting multiple streams and a method for transmitting multiple streams that load and transmit different information in a plurality of non-orthogonal polarized waves.

### BACKGROUND ART

The conventional communication technology is designed in such a manner that neighboring information signals are completely separated in a time domain and a frequency domain to be transmitted without interference while maintaining orthogonality. A non-orthogonal transmission scheme is researched due to an increase in traffic demand and the need of the non-synchronized transmission scheme. For example, Faster-than-Nyquist (FTN) signaling and filterbank multicarrier (FBMC) are proposed as the non-orthogonal transmission scheme.

Since two components (vertical and horizontal polarized waves or left-hand and right-hand circularly polarized waves) maintaining orthogonality are non to exist in a polarization region, only a maximum of two streams can be transmitted.

### SUMMARY OF THE INVENTION

The present invention has been made in an effort to provide an apparatus for transmitting multiple streams and a method for transmitting multiple streams that load and transmit different data on a plurality of non-orthogonal polarized waves. Furthermore, the present invention has been made in an effort to control and generate a polarized wave in a radio frequency domain by signal processing in a baseband.

The present invention has been made in an effort to provide a method for deriving a polarization angle between non-orthogonal polarized waves so as to restore data loaded on a plurality of non-orthogonal polarized waves with minimum error rate in a receiver while loading and transmitting different data on the plurality of non-orthogonal polarized waves.

An embodiment of the present invention provides an apparatus for transmitting multiple streams, including: a polarized wave control unit generating non-orthogonal polarization information for three or more input streams; a polarized wave generating unit controlling the three or more input streams in a baseband based on the non-orthogonal polarization information to generate vertical and horizontal polarization components; and a polarized wave transmitting unit transmitting the plurality of vertical and horizontal polarization components through dual polarization antennas.

The polarized wave control unit may calculate a polarization angle of each input stream in which a minimum distance between the synthesized polarized waves of three or more input streams becomes maximum to generate the non-orthogonal polarization information.

The polarized wave control unit may calculate a polarization angle of each input stream based on the number of the input streams.

In respect to synthesized polarized waves) Hs(i) and Hs(j) generated by the polarized wave control unit, the distance between two synthesized polarized waves is able to be expressed by HΔs=H(s(i)−s(j)) and the polarization angle is calculated so that a case in which a smallest value of HΔs=H(s(i)−s(j)) becomes largest.

The RF path correction control unit may calculate a correction value of an RF path that allows the control of the polarized wave in the baseband to be accurately reflected to a signal after antenna radiation.

The polarized wave transmitting unit may include a vertical multiplexer and a horizontal multiplexer.

The apparatus may further include a plurality of input sources providing the input streams.

Another embodiment of the present invention provides a method for transmitting multiple streams, including: generating non-orthogonal polarization information for three or more input streams; calculating correction values of vertical and horizontal RF paths for the three or more input streams; controlling the three or more input streams in a baseband based on the non-orthogonal polarization information and the RF path correction value to generate vertical and horizontal polarization components; and transmitting the plurality of vertical and horizontal polarization components through dual polarization antennas.

The generating of the non-orthogonal polarization information may include generating two or more synthesized polarized waves of the three or more input streams; and calculating a polarization angle of each input stream in which a minimum distance between the synthesized polarized waves becomes maximum to generate the non-orthogonal polarization information.

The generating of the non-orthogonal polarization information may include generating synthesized polarized waves of three or more input streams Hs(i) and Hs(j); and in a distance between two synthesized polarized waves which is HΔs=H(s(i)−s(j)), calculating the polarization angle so that a case in which a smallest value of HΔs=H(s(i)−s(j)) becomes largest.

The method may further include performing a simulation based on the number of cases which HΔs=H(s(i)−s(j)) is able to have in order to discriminate the case in which the distance between two synthesized polarized waves becomes a largest value.

According to embodiments of the present invention, non-orthogonal polarization components other than polarization components orthogonal to each other are used for transmitting multiple streams to enable large-capacity transmission.

Polarization angles capable of reducing an error can be set for the respective streams at the time of transmitting the non-orthogonal polarization components to thereby improve accuracy of the large-capacity transmission.

The embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the embodiments of the present invention. It can be easily known that the objects and advantages of the present invention can be implemented by the means and a combination thereof described in the appended claims.

### BRIEF DESCRIPTION OF THE DRAWINGS

FIG. 1 is a block diagram illustrating an apparatus for transmitting multiple streams according to an embodiment of the present invention.

FIG. 2 is a diagram illustrating a synthesized polarized wave of three input streams by using a BPSK modulation scheme for non-orthogonal linear polarized waves according to the embodiment of the present invention.

FIG. 3 is a diagram illustrating a distance between two synthesized polarized waves in accordance with 0 in available cases of respective input streams.

FIG. 4 is a flowchart for describing a method for transmitting multiple streams according to another embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the accompanying drawings. Like reference numerals refer to like elements in the drawings and a duplicated description of like elements will be omitted.

Specific structural or functional descriptions of embodiments of the present invention disclosed in the specification are made only for the purposes of describing the embodiments of the present invention, and the embodiments of the present invention may be carried out in various forms, and it should not be construed that the present invention is limited to the embodiments described in the specification.

Terms such as first, second, A, B, and the like may be used in describing the components of the embodiments according to the present invention. The terms are only used to distinguish a constituent element from another constituent element, but nature or an order of the constituent element is not limited by the terms.

The present invention relates to an apparatus and a method for transmitting multiple streams and a method for transmitting multiple streams by setting an optimal polarization angle for each of the multiple streams and controlling the set optimal polarization angle in a baseband in order to load and transmit different data on a plurality of non-orthogonal polarized waves by using dual polarization antennas.

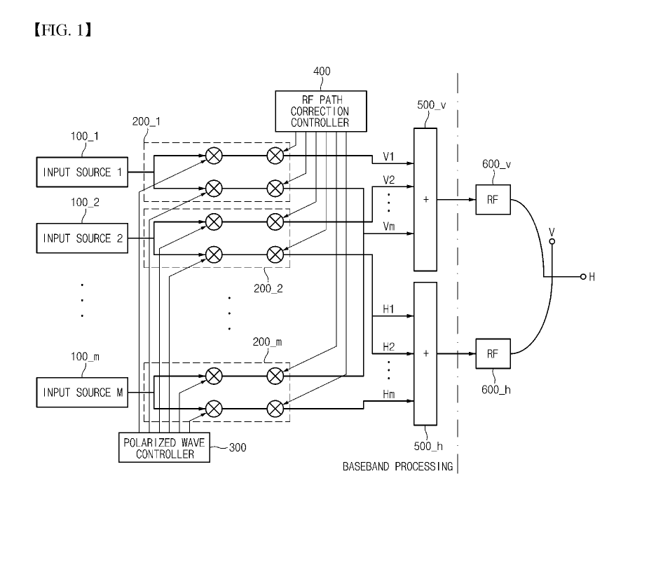

FIG. 1 is a block diagram illustrating an apparatus for transmitting multiple streams according to an embodiment of the present invention.

Referring to FIG. 1, the apparatus 10 for transmitting multiple streams may include a plurality of input sources 100_1, 100_2, . . . , 100_{—}m, a plurality of polarized wave generators 200_1, 200_2, . . . , 200_{—}m, a polarized wave controller 300, an RF path correction controller 400, polarized wave transmitting units 500_{—}v and 500_{—}h, and dual polarization antennas H and V.

The input sources 100_1, 100_2, . . . , 100_{—}m may include general communication components such as a channel encoder, an interleaver, and a modulator, respectively. The respective input sources 100_1, 100_2, . . . , 100_{—}m generate a plurality of input streams and provide the generated input streams to the polarized wave generators 200_1, 200_2, . . . , 200_{—}m.

The polarized wave generators 200_1, 200_2, . . . , 200_{—}m may receive non-orthogonal polarization information from the polarized wave controller 300. The polarized wave generators 200_1, 200_2, . . . , 200_{—}m may generate the multiple input streams by vertical and horizontal polarization component signals based on the non-orthogonal polarization information.

The polarized wave controller 300 may calculate an optimal polarization angle for the multiple input streams and generates the non-orthogonal polarization information (for example, ε and δ) for each stream to provide the generated information to each of the polarized wave generators 200_1, 200_2, . . . , 200_{—}m. In particular, in the present invention, the vertical and horizontal polarization components are implemented to be generated in a baseband based on the non-orthogonal polarization information.

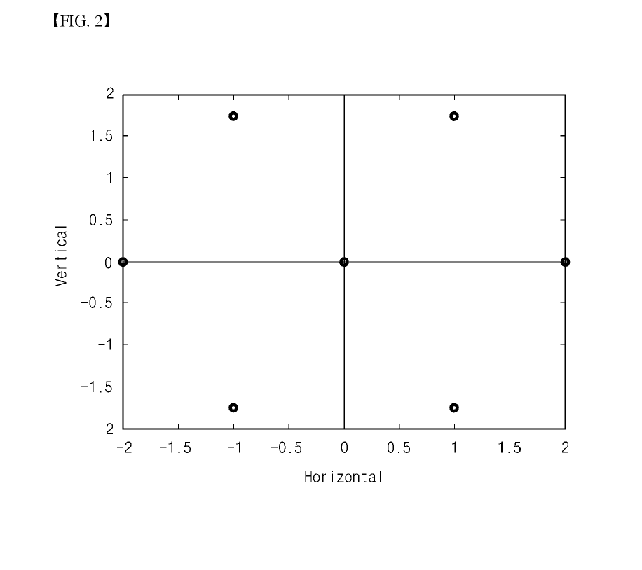

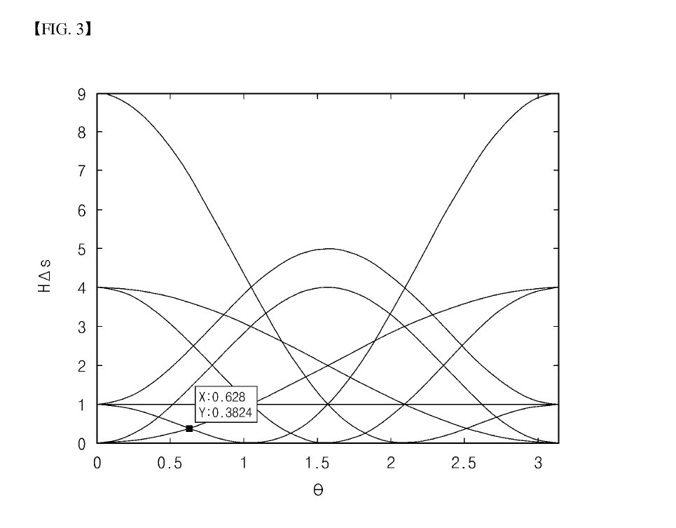

In the embodiment of the present invention, the polarized wave controller 300 generates the non-orthogonal polarization information for transmitting the multiple input streams by the non-orthogonal polarization signal. The non-orthogonal polarization information may be determined by calculating the optimal polarization angle so as to be restored in the receiver while minimizing interferences by the multiple input streams. The calculation of the optimal polarization angle of the polarized wave controller 300 will be described below with reference to FIGS. 2 and 3.

In the embodiment of the present invention, an RF path may be corrected in order to accurately reflect the control of the polarized wave in the baseband to a signal after antenna radiation.

The RF path correction controller 400 generates correction values of vertical and horizontal RF paths controlled in the baseband and provides the generated RF path correction information to the polarized wave generators 200_1, 200_2, . . . , 200_{—}m. In detail, the RF path correction controller 400 generates the RF path correction information so that paths of vertical and horizontal paths radiated by the dual polarization antennas H and V coincide with each other.

The polarized wave generators 200_1, 200_2, . . . , 200_{—}m generate final vertical and horizontal components of the multiple streams based on the RF path correction information as well as the non-orthogonal polarization information.

The polarized wave transmitting units 500_{—}v and 500_{—}h sum up vertical components V1, V2, . . . , Vm and horizontal components H1, H2, . . . , Hm received from the respective polarized wave generators 200_1, 200_2, . . . , 200_{—}m and transmit the summed-up components through the dual polarization antennas including a vertical antenna V and a horizontal antenna H. A vertical multiplexer 500_{—}v constituting the polarized wave transmitting units 500_{—}v and 500_{—}h receives the plurality of vertical components V1, V2, . . . , Vm to transmit the received vertical components V1, V2, . . . , Vm through the vertical antenna V.

A horizontal multiplexer 500_{—}h constituting the polarized wave transmitting units 500_{—}v and 500_{—}h receives the plurality of horizontal components H1, H2, . . . , Hm to transmit the received horizontal components H1, H2, . . . , Hm through the horizontal antenna H.

The apparatus 10 for transmitting multiple streams according to the present invention performs RF conversion after controlling the vertical and horizontal polarization components in the baseband. As a result, in some embodiments, the apparatus 10 for transmitting multiple streams may further include RF conversion units 600_{—}v and 600_{—}h. The RF conversion units 600_{—}v and 600_{—}h may perform the RF conversion of the vertical and horizontal components controlled in the baseband in the polarized wave transmitting units 500_{—}v and 500_{—}h and provide the RF-converted components to the dual polarization antennas H and V.

The RF path correction controller 400 calculates respective paths that reach the dual polarization antennas H and V by the RF conversion performed by the RF conversion units 600_{—}v and 600_{—}h to correct a deviation of both paths.

When sizes and phases of signal components supplied to the dual polarization antennas V and H are controlled, various types of polarized waves may be generated and may be expressed by Equation 1 given below.

E_{H}(t)=E cos εexp(jωt)

E_{V}(t)=E sin εexp(jδ)exp(jωt) [Equation 1]

Where, H and V represent the horizontal and vertical components, E represents transmission energy, and ω represents a used frequency. ε represents a relative ratio of the vertical and horizontal components and δ represents a relative delay of the vertical and horizontal components.

Respective polarization information may be expressed as illustrated in Equation 2.

$$ε = arctan \frac{\vert {E}_{V} ( t ) \vert}{\vert {E}_{H} ( t ) \vert} \\ δ = arg ( {E}_{H} ( t ) ) - arg ( {E}_{V} ( t ) ) \qquad [ Equation 2 ]$$

As described above, when the respective streams are transmitted by polarized waves orthogonal to each other, only a maximum of two streams may be transmitted. Since two streams do not interfere with each other, two streams may be restored in the receiver.

However, the streams are transmitted by permitting constant polarization interference between the streams and if the polarization interference may be removed in the receiver, the multiple streams may be transmitted.

The present invention proposes a method that transmits a signal with the non-orthogonal polarization angle in transmitting the multiple input streams, however, calculates an optimal polarization angle for minimizing the interference among the streams to generate the non-orthogonal polarization information.

A case in which three input streams using the BPSK modulation scheme for the non-orthogonal linear polarized wave (δ=0) will be described as an example.

When three input streams s₁, s₂, and s₃ are transmitted, modeling is enabled as illustrated in Equation 3 given below.

$$\begin{matrix}[ \begin{matrix}{E}_{H} \\ {E}_{V}\end{matrix} ] = [ \begin{matrix}cos ( {ε}_{1} ) \\ sin ( {ε}_{1} )\end{matrix} ] {s}_{1} + [ \begin{matrix}cos ( {ε}_{2} ) \\ sin ( {ε}_{2} )\end{matrix} ] {s}_{2} + [ \begin{matrix}cos ( {ε}_{3} ) \\ sin ( {ε}_{3} )\end{matrix} ] {s}_{3} \\ = [ \begin{matrix}1 \\ 0\end{matrix} ] {s}_{1} + [ \begin{matrix}cos ( θ ) \\ sin ( θ )\end{matrix} ] {s}_{2} + [ \begin{matrix}cos ( 2 θ ) \\ sin ( 2 θ )\end{matrix} ] {s}_{3} \\ = [ \begin{matrix}1 & cos ( θ ) & cos ( 2 θ ) \\ 0 & sin ( θ ) & sin ( 2 θ )\end{matrix} ] [ \begin{matrix}{s}_{1} \\ {s}_{2} \\ {s}_{3}\end{matrix} ] \\ = Hs\end{matrix} \qquad [ Equation 3 ]$$

In Equation 3, sᵢ represents i-th input stream data. A polarized wave of the first input stream S1 has a horizontal polarized wave (ε=0) as a reference, and a second input stream S2 and a third input stream S3 are separated into streams having polarization angels of 0 and 20, respectively.

According to a general observation, it is advantageous that θ=60° is set by trisecting the entirety of a 180° plane to maximize respective angular distances in transmitting the multiple input streams.

FIG. 2 is a diagram illustrating a synthesized polarized wave of three input streams by using by using a BPSK modulation scheme for non-orthogonal linear polarized waves according to the embodiment of the present invention.

As described above, when synthesized polarization components transmitted on each of horizontal and vertical planes are observed by polarizing the respective streams to ε=0°, ε=60°, and ε=120°, 8 polarization components should be observed in a normal case, but in FIG. 2, only 7 polarization components are observed.

The reason is that [−1 1 −1] and [1 −1 1] are identically mapped to an original point as seen with reference to FIG. 2. Therefore, two signals which are identically mapped is hard to be discriminated in the receiver.

The polarized wave control unit 300 according to the embodiment of the present invention generates the non-orthogonal polarization information of the multiple input streams through the following process.

First, the polarized wave control unit 300 generates two synthesized polarized waves, which are expressed by Hs(i) and Hs(j). A plurality of errors occurs in a part where a distance between two synthesized polarized waves is smallest in transmitting the synthesized polarized wave.

The distance between two synthesized polarized waves may be expressed as illustrated in Equation 4.

HΔs=H(s(i)−s(j)) [Equation 4]

Setting a smallest value of to have a largest value is a method for improving error performance. In other words, the synthesized polarized waves may have different values depending on values of the streams and a difference between the synthesized polarized waves becomes different while the streams are changed as described above and a distance between the synthesized polarized waves may be smallest at a certain point. Even in the case where the distance between the synthesized polarized waves is smallest, the distance between the synthesized polarized waves needs to be larger than other cases to minimize the errors which may occur at the time of transmitting the synthesized polarized waves. That is, a polarization angle when a minimum distance between the synthesized polarized waves has a largest value may minimize the error.

In the described example, each component of HΔs=H(s(i)−s(j)) has one value of −1, 0, and 1. As described above, since all cases depending on values of the streams need to be determined, a simulation may be performed based on the number of cases which HΔs=H(s(i)−s(j)) may have.

FIG. 3 is a diagram illustrating a distance between two synthesized polarized waves in accordance with 0 in available cases of respective input streams.

Referring to FIG. 3, 7 graphs are illustrated in respect to a case for each component of HΔs=H(s(i)−s(j). HΔs=H(s(i)−s(j)) has one value of −1, 0, and 1 as described above and the total number of the cases is 8, but the case of [0 0 0] is not illustrated. Therefore, the distance between the synthesized polarized waves is illustrated in respect to all of 7 cases.

In the respective cases, when θ is close to values of 0, 1, 1.5, 2, and 3 radians, the minimum distance is close to approximately 0. Therefore, when a value of θ has the corresponding value, since some synthesized polarized waves are completely duplicated with each other depending on the values of the streams, restoring the steams is impossible.

It is observed that the minimum value of the distance between the synthesized polarized waves has the largest value while the value of θ is approximately 0.6 or 2.5 radians. Among them, when θ=0.628 radians as illustrated in FIG. 3, the minimum value of HΔs=H(s(i)−s(j)) becomes maximum as 0.3824.

That is, in this case, although the distance between the synthesized polarized waves becomes minimum, since a gap between the synthesized polarized waves is larger than other cases, the interference between the synthesized polarized waves is small, and as a result, the input stream is easily restored in the receiver.

As a result, θ is determined, and the non-orthogonal polarization information of the second input stream S2 and the third input stream S3 is generated according to the determined θ value. The polarized wave generators 200_1, 200_2, . . . , 200_{—}m generate the respective input streams by the vertical and horizontal polarization components based on the non-orthogonal polarization information and transmit the generated vertical and horizontal polarization components through the dual polarization antennas H and V.

As described above, the polarized wave control unit 300 according to the embodiment of the present invention generates a synthesized polarized wave of three or more input streams based on the number of input sources 100_1, 100_2, . . . , 100_{—}m and generates the non-orthogonal polarization information by a scheme to maximize a minimum distance between the synthesized polarized waves.

In the specification, it is described that the number of input streams of the non-orthogonal linear polarized wave is assumed as three, the non-orthogonal polarization information may be generated in a similar scheme even for the plurality of input streams of the non-orthogonal polarized waves having different ε and δ values.

That is, the polarized wave controller 300 generates two or more synthesized polarized waves through modeling for three or more input streams and generates the non-orthogonal polarization information which may maintain a largest value even when the gap between the synthesized polarized waves is smallest.

As a result, the non-orthogonal polarization information may be determined based on the number of input streams.

The apparatus 10 for transmitting multiple streams according to the embodiment of the present invention may increase signal density by transmitting the non-orthogonal polarization signals through the dual polarization antennas and improve signal recognition rate in the receiver by maximizing the distance between the synthesized polarized waves.

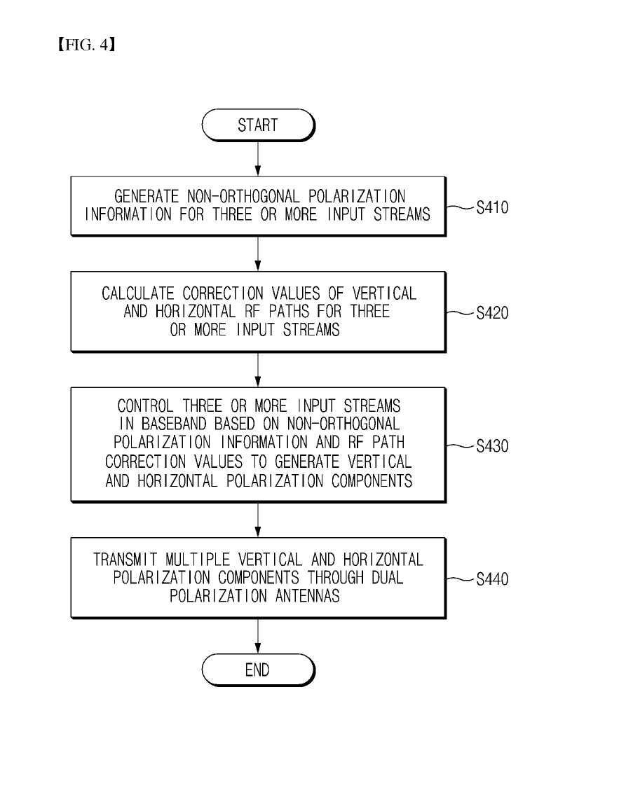

FIG. 4 is a flowchart for describing a method for transmitting multiple streams according to another embodiment of the present invention.

Referring to FIG. 4, a polarized wave controller 300 generates non-orthogonal polarization information for three or more input streams (step S410). As described above, the non-orthogonal polarization information may be determined according to a value in which a minimum distance between synthesized polarized waves generated based on three or more input streams becomes maximum. Therefore, in some embodiments, the non-orthogonal polarization information may be determined according to the number of input streams.

Since the transmission of the multiple streams according to the present invention is RF-converted after vertical and horizontal polarization components controlled in a baseband, an RF path correction controller 400 calculates an RF path correction value for vertical and horizontal polarization components generated for each of the input streams (step S420).

The polarized wave generators 200_1, 200_2, . . . , 200_{—}m generate the input streams as the vertical and horizontal polarization components by controlling the input streams in the baseband based on the non-orthogonal polarization information and the RF path correction information value (step S430). The vertical and horizontal polarization components are provided to polarized wave transmitting units 500_{—}v and 500_{—}h.

The vertical and horizontal polarization components are transmitted through dual polarization antennas H and V (step S440). According to the embodiment, the vertical and horizontal polarization components may be RF-converted before being provided to the dual polarization antennas H and V.

Although the present invention described as above is not limited by the aforementioned embodiments and the accompanying drawings and it will be apparent to those skilled in the art that various substitutions, modifications, and changes can be made within the scope without departing from the technical spirit of the present invention.

What is claimed is:

1. An apparatus for transmitting multiple streams, the apparatus comprising:
a polarized wave control unit configured to generate non-orthogonal polarization information for three or more input streams;
a polarized wave generating unit configured to control the three or more input streams in a baseband based on the non-orthogonal polarization information to generate vertical and horizontal polarization components; and
a polarized wave transmitting unit configured to transmit the plurality of vertical and horizontal polarization components through dual polarization antennas.

2. The apparatus of claim 1, further comprising:
an RF path correction control unit configured to match RF paths between the vertical and horizontal polarization components, and the dual polarization antennas.

3. The apparatus of claim 2, wherein the polarized wave control unit configured to generate two or more synthesized polarized waves of the three or more input streams, calculate a polarization angle of each input stream in which a minimum distance between the synthesized polarized waves becomes a largest, and generate the non-orthogonal polarization information.

4. The apparatus of claim 3, wherein the polarized wave control unit configured to calculate a polarization angle of each input stream based on the number of the input streams.

5. The apparatus of claim 3, wherein in respect to synthesized polarized waves Hs(i) and Hs(j) generated by the polarized wave control unit,
the distance between two synthesized polarized waves is expressed by
HΔs=H(s(i)−s(j))
the polarization angle is calculated where a smallest value of HΔs=H(s(i)−s(j)) becomes largest.

6. The apparatus of claim 1, wherein the polarized wave transmitting unit includes a vertical multiplexer and a horizontal multiplexer.

7. The apparatus of claim 1, further comprising:
a plurality of input sources providing the input streams.

8. A method for transmitting multiple streams, the method comprising:
generating non-orthogonal polarization information for three or more input streams;
calculating correction values of vertical and horizontal RF paths for the three or more input streams;
controlling the three or more input streams in a baseband based on the non-orthogonal polarization information and the RF path correction value to generate vertical and horizontal polarization components; and
transmitting the plurality of vertical and horizontal polarization components through dual polarization antennas.

9. The apparatus of claim 8, wherein the generating of the non-orthogonal polarization information includes:
generating two or more synthesized polarized waves of the three or more input streams; and
calculating a polarization angle of each input stream in which a minimum distance between the synthesized polarized waves becomes maximum to generate the non-orthogonal polarization information.

10. The method of claim 8, wherein the generating of the non-orthogonal polarization information includes:
generating synthesized polarized waves of the three or more input streams Hs(i) and Hs(j); and
in a distance between two synthesized polarized waves which is HΔs=H(s(i)−s(j)),
calculating the polarization angle so that a case in which a smallest value of HΔs=H(s(i)−s(j)) becomes largest.

11. The method of claim 10, further comprising:
performing a simulation based on the number of cases which HΔs=H(s(i)−s(j)) is able to have in order to discriminate the case in which the distance between two synthesized polarized waves becomes a largest value.

12. The method of claim 8, wherein transmitting the plurality of polarization components through dual polarization antennas includes RF-converting the plurality of polarization components.
